(19) United States
(12) Patent Application Publication
(10) Pub. No.: US 2003/0167708 A1
(43) Pub. Date: Sep. 11, 2003

(54) Underground storm shelter

(76) Inventors: Michael D. Shaw, Ponca City, OK (US); David L. Sharp, Blackwell, OK (US)

Correspondence Address: Dunlap, Codding & Rogers, P.C., Suite 420, 9400 North Broadway, Oklahoma City, OK, 73114, US

(21) Appl. No.: 10/096,439

(22) Filed: Mar. 11, 2002

(51) Int. Cl. E06B 9/04

(52) U.S. Cl. 52/169.6; 109/18

(57) ABSTRACT

An underground shelter having a seamless housing, a lid assembly, and a latch mechanism. The seamless housing is provided with a closed bottom, a sidewall, an open top, and a shelter cavity. The lid assembly is attached to the seamless housing and extends across the open top of the seamless housing. The lid assembly has a door frame and a door assembly attached to the door frame.

### CROSS REFERENCE TO RELATED APPLICATION

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates generally to storm shelters, and more particularly, but not by way of limitation, to an improved underground storm shelter having a lightweight seamless housing and a lid assembly attached thereto.

2. Description of the Related Art

Underground storm shelters have been known in the art for many years. Such storm shelters have generally been constructed from multiple metal plates fashioned together to form a box-like housing that is sized to accommodate a number of individuals. A lid assembly is provided to permit ingress and egress from the housing.

While storm shelters of this type have generally been accepted by the industry, many problems are encountered in the use of such storm shelters. For example, the metal plates that form the housing are typically welded together, thus forming seams between the plates. Depending on the quality of the welds, the seams can leak. In addition, over time the metal plates rust in the ground and eventually break down causing leakage and requiring the storm shelter to be replaced.

To this end, a need exists for a storm shelter which includes a seamless, non-metal housing adapted to be buried in the ground and a lid assembly which permits easy ingress into and egress from the housing while also providing a solid barrier from flying debris.

### BRIEF DESCRIPTION OF THE DRAWINGS

FIG. 1 is a perspective view of an underground shelter constructed in accordance with the present invention.

FIG. 2 is an exploded, perspective view of the underground shelter.

FIG. 3 is a partial cutaway end elevational view of the underground shelter.

FIG. 4 is a cross sectional view of circle 4-4 of FIG. 3.

FIG. 5 is a cross-sectional view illustrating a latch mechanism.

FIG. 6 is a partial, cross-sectional view of the underground shelter shown installed in the ground.

FIG. 7 is an end elevational view of another embodiment of an underground shelter constructed in accordance with the present invention.

FIG. 8 is a side elevational view of the underground shelter of FIG. 7 without the lid assembly.

### DETAILED DESCRIPTION

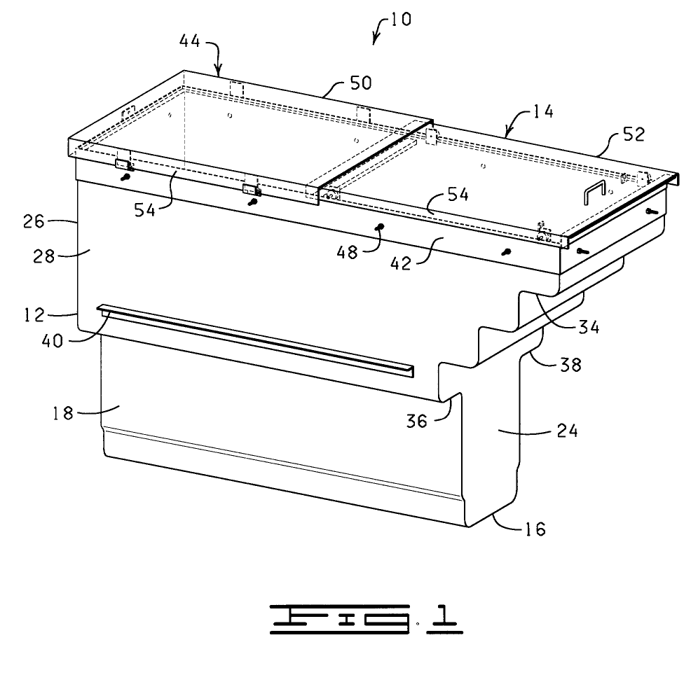

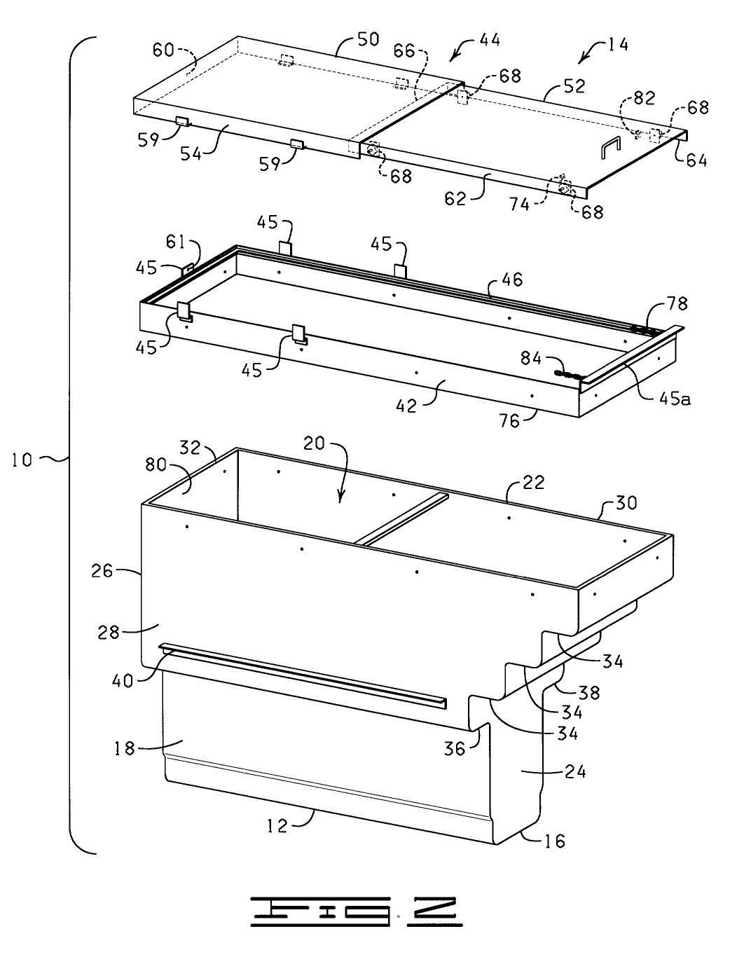

Referring now to the drawings, and in particular to FIGS. 1 and 2, shown therein and designated by the general reference number 10 is an underground storm shelter constructed in accordance with the present invention. The storm shelter 10 includes a seamless housing 12 adapted to be buried in the ground to provide a water proof shelter cavity and a lid assembly 14 which is attached to the seamless housing 12 to permit an individual to pass to and from the shelter cavity while also providing a solid barrier from flying debris and falling.

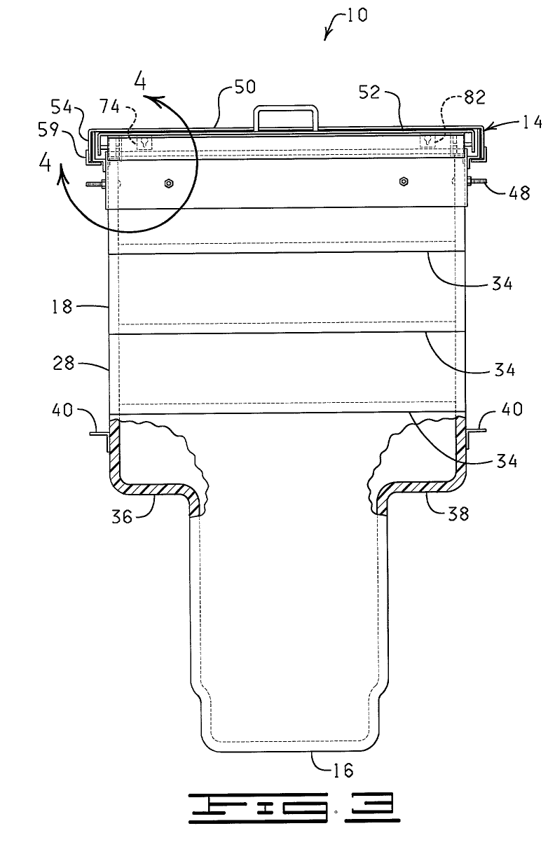

The seamless housing 12 is shown herein to have a substantially rectangular shape. More specifically, the seamless housing 12 has a closed bottom 16, a side wall 18 extending upwardly to cooperate with the closed bottom 16 to define a shelter cavity 20, and an open top 22. The side wall 18 includes a first end 24, a second end 26, a first side 28, a second side 30, and an upper peripheral edge 32. The first end 24 of the side wall 18 is formed to have a plurality of steps 34 to facilitate ingress to and egress from the shelter cavity 20. The first side 28 is formed to have an inwardly extending shelf 36 (FIGS. 1, 2, and 3) which extends from the first end 24 to the second end 26. Likewise the second side 30 is formed to have an inwardly extending shelf 38 (FIGS. 1, 2, and 3) which extends from the first end 24 to the second end 26. The shelves 36 and 38 are sized and positioned to serve as benches or seats for individuals seeking refuge in the underground storm shelter 10 during a storm, as best illustrated in FIG. 3.

The seamless housing 12 further has a longitudinal flange 40 formed along the first side 28 and the second side 30 of the side wall 18. The flanges 40 are used to retain the seamless housing 12 in the ground in a manner to be discussed in greater detail below.

To prevent fluid leakage into the seamless housing 12, the seamless housing 12 is a constructed as a monolithic or one piece unit to eliminate substantially all seams and lines of connection that might provide a channel or opening for fluid to pass through the side wall 18 and into the shelter cavity 20. An example of a material suitable for constructing the seamless housing 12 is a reinforced fiberglass comprising about one half inch thick polyester structural foam laminated between two layers of fiberglass. Such a construction enables the seamless housing 12 to withstand a force of approximately 20,000 psi. However, it will be appreciated that the seamless housing 12 can be constructed as a one piece, waterproof unit from a variety of materials, including plastic.

Referring now to FIGS. 1-5, the lid assembly 14 includes a door frame 42 and a door assembly 44. The door frame 42 is adapted to be connected to the seamless housing 12 and to support the door assembly 44 over the open top 22 of the seamless body 12. The door frame 42 and the door assembly 44 are each constructed of a high strength material, such as steel, in order that flying and falling debris is prevented from penetrating into the shelter cavity 20.

The door frame 42 is sized and shaped to fit about the seamless body 12 with a portion of the door frame 42 extending above the upper peripheral edge 32 of the side wall 18 of the seamless housing 12 and the remaining portion extending down a distance over the outer surface of the side wall 18.

A plurality of support brackets 45 are secured to the outer side of the door frame 42 near one end thereof so as to extend above and away from the door frame 42. Another support bracket 45a is provided along the opposite end of the door frame 42. Finally, a roller track 46 is secured along the inner side of the door frame 42. As shown in FIG. 4, the roller track 46 is a length of angle iron secured to the inner side of the door frame 42. The upper peripheral edge 32 of the seamless housing 12 can be notched to receive the roller tracks 46, as shown. The door frame 42 is connected to the seamless housing 12 with a plurality of fasteners 48, such as carriage bolts.

The door assembly 44 of the lid assembly 14 includes a floating lid 50 connectable to the door frame 42 and a rolling lid 52 slidable relative to the floating lid 50 between an open position to permit passage to and from the shelter cavity 20 and a closed position wherein the floating lid 50 and the rolling lid 52 cooperate to provide a barrier against flying and falling debris. The floating lid 50 is a substantially flat plate with a downwardly extending edge 54 along three sides of the floating lid 50. The floating lid 50 is sized to extend over the support brackets 45 and cover approximately one half of the open top 22 of the seamless housing 12.

To secure the floating lid 50 to the door frame 42, the floating lid 50 is provided with a plurality of latching tabs 59. Each of the latching tabs 59 is attached to the floating lid 50 in a spaced apart relation so as to correspond to the support brackets 45. The latching tabs 59 engage a lower side of the support brackets 45 to secure the floating lid 50 to the door frame 42 upon sliding the floating lid 50 into a position where the latching tabs 59 are aligned with the support brackets 45. The floating lid 50 is further secured to the door frame 42 with a locking pin (not shown) which is insertable through an opening 60 (FIG. 2) formed in the downwardly extending edge 54 of the floating lid 50 and an opening 61 formed in the corresponding support bracket 45 from within the shelter cavity 20.

Like the floating lid 50, the rolling lid 52 is a relatively flat plate with a pair of downwardly extending edges 62 and 64 and an upwardly extending lip 66 (FIG. 2), which prevents water from flowing into the shelter cavity 20 between the rolling lid 52 and the floating lid 50. The rolling lid 52 is provided with a plurality of rollers 68 spaced to rollingly support the rolling lid 52 on the roller tracks 46 of the door frame 42. The rolling lid 52 is sized to slide within the floating lid 50 and cover the remaining portion of the open top 22 of the seamless housing 12 when the rolling lid 52 is in the closed position.

As best shown in FIG. 4, the downwardly extending edge 54 of the floating lid 50 and downwardly extending edges 62 and 64 of the rolling lid 52 extend a distance below the upper edge of the door frame 42 to prevent debris from flying or shooting into the shelter cavity 20. Further, the downwardly extending edge 54 of the floating lid 50 and the downwardly extending edges 62 and 64 of the rolling lid 52 are spaced from the door frame 42 so as to form an air flow channel or passageway 71 between the door frame 42 and the floating lid 50 and the rolling lid 52 to permit air flow to and from the shelter cavity 20.

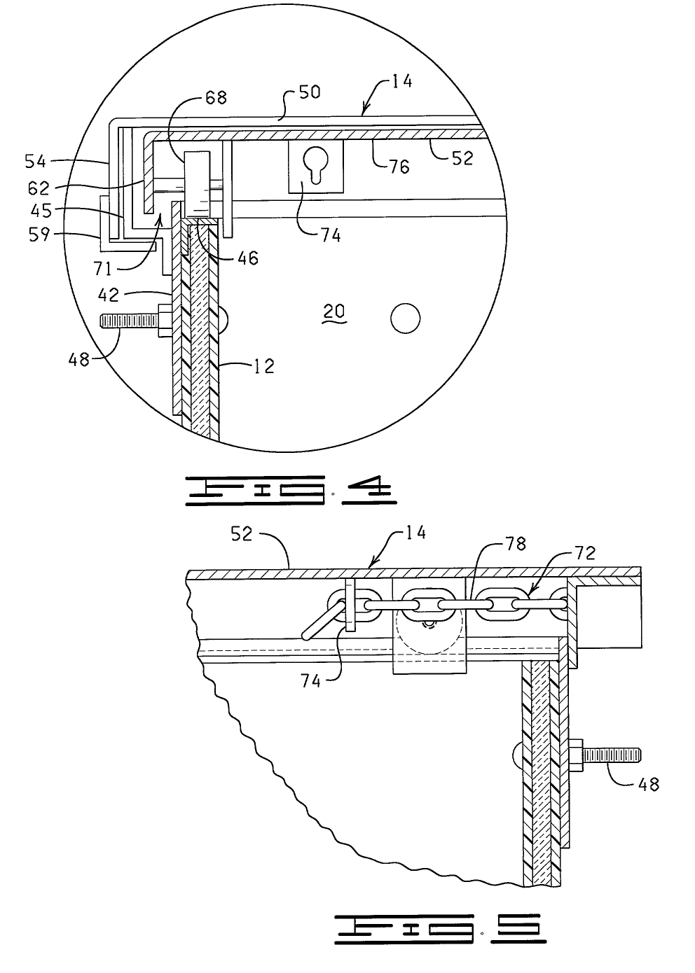

The open position of the rolling lid 52 provides those seeking refuge in the storm shelter 10 access to the shelter cavity 20 through the lid assembly 14. Once a person enters the shelter cavity 20, the rolling lid 52 can be secured from inside the shelter cavity 20 using a latch mechanism 72. As best illustrated in FIG. 5, the latch mechanism 72 includes a first keyhole latch plate 74 attached to a bottom surface of the rolling lid 52 and a first length of chain 78. One end of the first length of chain 78 is attached to an inside surface 80 of the door frame 42. The latch mechanism 72 further includes a second keyhole latch plate 82 (FIG. 3) attached to the bottom surface of the rolling lid 52 in a spaced apart relation relative to the first keyhole latch plate 74. A second length of chain 84 (FIG. 2) has one end attached to the inside surface of the door frame 42, as shown.

The first length of chain 78 and the second length of chain 84 are each lockingly engageable with the first and second keyhole latch plates 74 and 82, respectively. FIG. 5 depicts the latch mechanism 72 in its locked position as described above. The second end of the first length of chain 78 is shown lockingly engaged with the first keyhole latch plate 74, thereby securing the rolling lid 52 in the closed position.

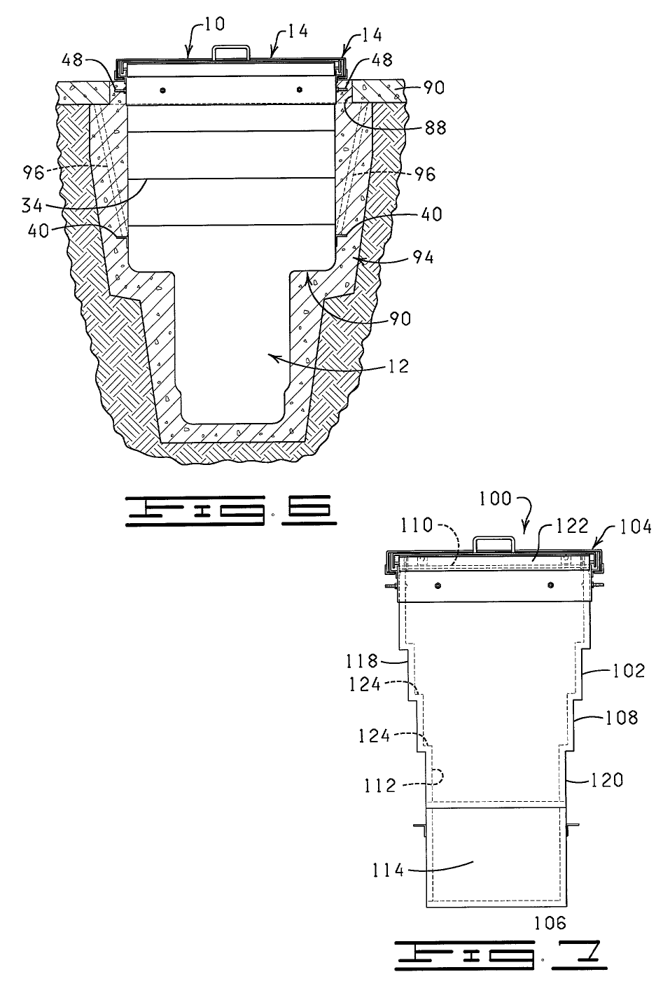

Turning now to FIG. 6, shown therein is the underground shelter 10 shown installed in the ground. The underground storm shelter 10 is shown inserted in a hole 88 in a concrete slab 90 is removed and the hole 88 is dug into the ground beneath. The underground shelter 10 is then inserted into a hole 88 such that the fasteners 48 are positioned below the upper surface of a concrete slab 90 while the door assembly 44 is spaced above the concrete slab 90 to permit the rolling lid 52 to slide freely between the open position and the closed position.

A securing material 94, such as concrete, is inserted into the hole 88 around the underground storm shelter 10. The fasteners 48 are embedded in the securing material 94 to further support the storm shelter 10 in the hole 88. Prior to inserting the securing material 94 in the hole 88, support bars 96 are positioned between the bottom surface of the concrete slab 90 and the flanges 40 of the seamless housing 12 to further secure the storm shelter 10 in the hole 88.

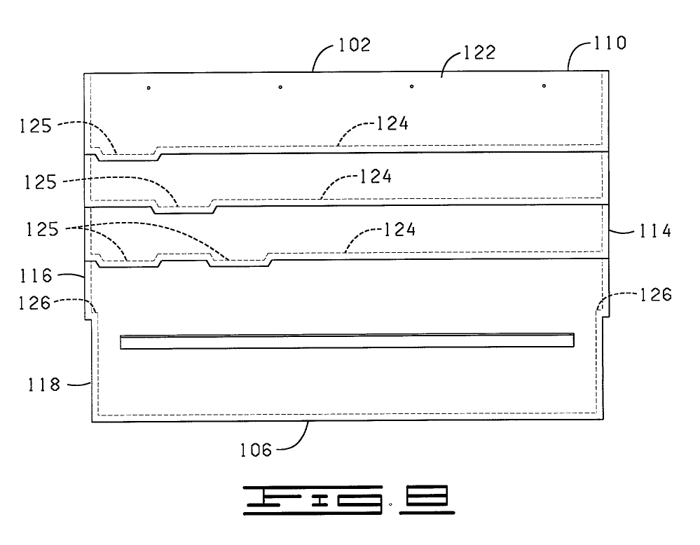

Referring now to FIGS. 7 and 8, shown therein and designated by reference numeral 100, is another embodiment of an underground storm shelter constructed in accordance with the present invention. The underground storm shelter 100 has a seamless housing 102 and a lid assembly 104 (FIG. 7). The underground storm shelter 100 is similar in construction and function to the underground storm shelter 10 hereinbefore described in detail with reference to FIGS. 1-6, except as discussed hereinafter. The seamless housing 102 has a closed bottom 106, a side wall 108, and an open top 110 for providing passage into and out from a shelter cavity 112 defined by the seamless housing 102. The side wall 108 includes a first end 114, a second end 116, a first side 118, a second side 120, and an upper peripheral edge 122.

The first end 114 of the seamless housing 102 is provided with inwardly extending longitudinal indentations 124, each provided with inner notches 125 for receiving and supporting support members (not shown), such as boards, for use as steps for ingress to and egress from the shelter cavity 112. The support members are removable and adjustable within the notches 125 according to the user's preference. The support members can be removed to provide added storage or seating space within the shelter cavity 112. Shown in FIG. 8, the seamless housing 102 also has inwardly extending indentations 126 along the length of the underground storm shelter 100 for support of support members, such as boards, (not shown)for providing benches inside the shelter cavity 112.

Changes may be made in the embodiments of the invention described herein, or in the parts or the elements of the embodiments described herein or in the steps or sequence of steps of the methods described herein without departing from the spirit and/or the scope of the invention as defined in the following claims.

What is claimed is:

1. An underground shelter comprising:
a housing formed from a nonmetal material, the housing having a closed bottom, a sidewall extending upwardly to cooperate with the closed bottom to define a shelter cavity, and an open top; and
a lid assembly attached to the housing so as to extend across the open top thereof, the lid assembly having a door frame connected to the side wall of the seamless housing and a door assembly attached to the door frame which is movable from an open position to permit passage to and from the shelter cavity to a closed position wherein the door assembly provides a barrier to flying and falling debris.

2. The underground shelter of claim 1 wherein the lid assembly has a latch mechanism attached to the forward edge of the door assembly for securing the door in the closed position.

3. The underground shelter of claim 1 wherein the housing is constructed from a material selected from the group consisting of fiberglass, structural foam, plastic, and combinations thereof.

4. The underground shelter of claim 1 wherein the lid assembly is formed of a rigid metal material.

5. The underground shelter of claim 1 wherein the side wall of the housing has at least one adjacently attached flange for anchoring a rebar to the housing.

6. The underground shelter of claim 1 wherein the housing is formed to have at least one inwardly extending shelf forming a seat within the housing.

7. The underground shelter of claim 1 wherein the door frame of the lid assembly extends over at least a portion of the side wall of the seamless housing and is connected thereto.

8. The underground shelter of claim 1 wherein the door of the lid assembly includes a floating lid connectable to the door frame and a rolling lid slidable relative to the floating lid, the rolling lid and the floating lid each having a downwardly extending edge, the rolling lid and the floating lid are supported in a spaced apart relation with respect to the door frame with the downwardly extending edge of the rolling lid and the floating lid extending below the upper peripheral edge of the door frame so as to form an air flow channel between the door frame and the rolling lid and floating lid to permit air flow to and from the shelter cavity.

9. The underground shelter of claim 8 wherein the floating lid is secured to the door frame with a locking pin.

10. The underground shelter of claim 1 wherein the lid assembly has a pair of longitudinally extending tracks mounted in the door frame, a door assembly comprising a floating lid secured to the inner wall with a locking pin and a rolling lid slidable relative to the floating lid between an open position and a closed position, the rolling lid having a raised lip at one end thereof for preventing water from entering the space between the floating lid and the rolling lid, the rolling lid having rollers thereon adapted to rollingly engage the tracks.

11. The underground shelter of claim 2 wherein the latch mechanism comprises a first keyhole latch plate attached to a bottom surface of the door assembly and a first length of chain having one end attached to an inside surface of the door frame and a second end lockingly engageable with the first keyhole latch plate and a second keyhole latch plate attached to the bottom surface of the door assembly in a spaced relationship relative to the first keyhole latch plate and a second length of chain having one end attached to the inside surface of the door frame and a second end lockingly engageable with the second latch plate.

12. An underground shelter comprising:
a seamless housing formed from a nonmetal material, the housing having a closed bottom, a sidewall extending upwardly to cooperate with the closed bottom to define a shelter cavity, and an open top; and
a lid assembly attached to the seamless housing so as to extend across the open top thereof, the lid assembly having a door frame connected to the side wall of the seamless housing and a door assembly attached to the door frame which is movable from an open position to permit passage to and from the shelter cavity to a closed position wherein the door assembly provides a barrier to flying and falling debris.

13. The underground shelter of claim 12 wherein the lid assembly has a latch mechanism attached to the forward edge of the door assembly for securing the door in the closed position.

14. The underground shelter of claim 12 wherein the seamless housing is formed as a monolithic unit.

15. The underground shelter of claim 12 wherein the seamless housing is constructed from a material selected from the group consisting of fiberglass, structural foam, plastic, and combinations thereof.

16. The underground shelter of claim 12 wherein the lid assembly is formed of a rigid metal material.

17. The underground shelter of claim 12 wherein the side wall of the seamless housing has at least one adjacently attached flange for anchoring a rebar to the seamless housing.

18. The underground shelter of claim 12 wherein the seamless housing is formed to have at least one inwardly extending shelf forming a seat within the seamless housing.

19. The underground shelter of claim 12 wherein the door frame of the lid assembly extends over at least a portion of the side wall of the seamless housing and is connected thereto.

20. The underground shelter of claim 12 wherein the door of the lid assembly includes a floating lid connectable to the door frame and a rolling lid slidable relative to the floating lid, the rolling lid and the floating lid each having a downwardly extending edge, the rolling lid and the floating lid are supported in a spaced apart relation with respect to the door frame with the downwardly extending edge of the rolling lid and the floating lid extending below the upper peripheral edge of the door frame so as to form an air flow channel between the door frame and the rolling lid and floating lid to permit air flow to and from the shelter cavity.

21. The underground shelter of claim 20 wherein the floating lid is secured to the door frame with a locking pin.

22. The underground shelter of claim 12 wherein the lid assembly has a pair of longitudinally extending tracks mounted in the door frame, a door assembly comprising a floating lid secured to the inner wall with a locking pin and a rolling lid slidable relative to the floating lid between an open position and a closed position, the rolling lid having a raised lip at one end thereof for preventing water from entering the space between the floating lid and the rolling lid, the rolling lid having rollers thereon adapted to rollingly engage the tracks.

23. The underground shelter of claim 13 wherein the latch mechanism comprises a first keyhole latch plate attached to a bottom surface of the door assembly and a first length of chain having one end attached to an inside surface of the door frame and a second end lockingly engageable with the first keyhole latch plate and a second keyhole latch plate attached to the bottom surface of the door assembly in a spaced relationship relative to the first keyhole latch plate and a second length of chain having one end attached to the inside surface of the door frame and a second end lockingly engageable with the second latch plate.

24. A method of providing a shelter in the ground, comprising the steps of:
providing a seamless housing formed from a non-metal material, the housing having a closed bottom, a side wall extending upwardly to cooperate with the closed bottom to define a shelter cavity, and an open top;
attaching a lid assembly to the seamless housing so that the lid assembly extends across the open top thereof, the lid assembly having a door frame connected to the side wall of the seamless housing and a door assembly attached to the door frame which is movable from an open position to permit passage to and from the shelter cavity to a closed position wherein the door assembly provides a barrier to flying and falling debris;
forming a hole in the ground;
inserting the seamless housing into the hole with the lid assembly positioned above the hole; and
securing the seamless housing in the hole by filling the remainder of the hole with a securing material.

25. The method of claim 24 wherein the step of attaching the lid assembly to the seamless housing comprises extending the door frame over at least a portion of the sidewall of the seamless housing and securing the door frame to the seamless housing with a plurality of fasteners.

26. The method of claim 25 wherein the fasteners extend a distance away from the door frame.

27. The method of claim 26 wherein the step of inserting the seamless housing into the hole further includes positioning the seamless housing in the hole so that the fasteners are positioned below ground level.

28. The method of claim 27 wherein the step of securing the seamless housing in the hole further includes the step of encompassing the portions of the fasteners extending from the door frame with the securing material to enhance securement of the seamless housing in the hole.
